(19) United States
(12) Patent Application Publication
(10) Pub. No.: US 2008/0249897 A1
(43) Pub. Date: Oct. 9, 2008

(54) Electronic Commerce System for the Digital Fashion Using an Avatar Based on a User and Method for Operating the Same

(75) Inventors: Uk Oh, Seoul (KR); Jae Chul Kim, Seoul (KR); Jung Hwan Lee, Seoul (KR); Du Hwan Yeo, Seoul (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SK C&C CO. LTD, Gyeonggi-do (KR)

(21) Appl. No.: 12/088,230

(22) PCT Filed: Aug. 23, 2006
(86) PCT No.: PCT/KR2006/003322

§ 371 Date: Mar. 26, 2008

(30) Foreign Application Priority Data
Sep. 30, 2005 (KR) 10-2005-0091812
Sep. 30, 2005 (KR) 10-2005-0091813

(51) Int. Cl. G06Q 30/00; G06F 3/048; G06T 15/00

(52) U.S. Cl. 705/27; 715/810; 345/419

(57) ABSTRACT

A shopping-mall system utilizing user-based avatars comprises a terminal for transmitting user's three-dimensional image data through a wired or wireless communication network and then selecting any one of items provided through the wired or wireless communication network to receive an avatar image wearing the selected item and to transmit purchase specification information for purchasing the selected item. An avatar creation server receives the three-dimensional image data from the terminal and then creates an avatar image. A three-dimensional shopping-mall server puts any one item selected among a plurality of items stored therein on the avatar image created by the avatar creation server to provide the terminal with the avatar image wearing the item, and then performs an electronic commerce transaction with the terminal on the receipt of the purchase specification information of the selected item.

### TECHNICAL FIELD

The present invention relates to an electronic commerce system for the digital fashion using an avatar based on a user and method for operating the same, and more particularly, to an electronic commerce system for fashion products utilizing avatar images each having the same appearance as a user and an operating method thereof.

### BACKGROUND ART

As the mobile market emerges to be a topic subject in the information technology (IT) industry, mobile contents industry occupies a big portion of the IT industry in many countries. According to Cahner IN-STAT Group, the wireless information market amounting to 170 million dollars worldwide in 2002 has grown up to 1300 million dollars in scale. Further, it is expected that message transfer services will be first started for the time being, and then, the services will be spread into M-commerce applications, entertainments, real-time banking information, travel, and location information services.

In the mobile contents market of the United States, contents in the fields of e-commerce and e-business services, which are used for doing business efficiently rather than fulfilling personal interests, have been developed. Currently, due to the limitations in the wireless infrastructure, the service spread widely in the United States is the short message service by which a user can conveniently send an e-mail or a message through a mobile communication. The monthly average of the short message service has been escalated from 3 billions in 1999 to 244 billions in 2004.

Mobile contents in Europe are closely associated with topographical features of the European continent. In Finland, due to the regional characteristic of cold weather, mobile contents are popularized to an extent that a mobile phone is used to pay for vending machine drinks, parking, car washing or the like. In addition, value added information (VAI) services, such as providing financial information or news, making a reservation or the like, which reflect the characteristics of European major culture of politics, economy and finance, have been developed.

As described above, mobile contents in the United States and Europe reflect regional and cultural characteristics and have been developed in information transfer services based on e-mail or short message services (SMS) as well as VAI services aiming at evolution into m-commerce rather than in individual-oriented services. Further, mobile banking (m-banking) based sales and transactions using mobile communications have been gradually prepared. Furthermore, it is expected that in order to beforehand occupy the mobile market, competitions for securing contents will be heated between the contents providers who have led the existing Internet market and mobile communication companies who desire to lead the new wireless communication market.

On the other hand, the mobile contents industry in Asia regions also forms a big market. With the rapid increase in mobile populations, the scale of the m-commerce market in Korea has passed 3 billion dollars in 2004, and the scale in China has reached nearly 3 billion dollars in 2004. Accordingly, the mobile contents industry in the future will be astonishingly grown to make a major market in the IT industry.

A character-related industry may be included in such a mobile contents industry.

Currently, the character industry is recognized as a high value-added business, which can maximize effects of items using characters and create a variety of brands. Generally, in selling products or providing services, the character industry tends to utilize, for marketing purposes, such features as the ability of attracting customers, the power of monopolizing the market, the differentiation of their products from other company's, the enhancement of name value, and the like. In other words, individualities of a character such as a name, personality, behavior and voice are developed together with external features of the character, and such individualities of the character are merged into a product or a service to create a sense of closeness to the product or service.

As described above, in the character industry, particularly in the avatar-related industry, services for downloading and using arbitrary avatars at a mobile communication terminal as well as in a wired environment are recently spotlighted owing to the wide spread of mobile communication terminals and the technology advancement.

Such avatars are registered in a directory and used as a background screen or for showing the other party when sending a message or making a phone call. Since the avatars are more frequently used day after day, methods of expressing a user further in a realistic and distinguishable way have been studied.

However, since the aforementioned conventional avatar service employs avatars that have been previously created by designers, there are problems in that the avatars are quite unlike the users in appearance, and they also look too different to represent the users.

### DISCLOSURE OF INVENTION

### Technical Problem

The present invention is conceived to solve the aforementioned problems. Accordingly, an object of the present invention is to provide an electronic commerce system for the digital fashion using an avatar based on a user and method for operating the same, wherein electronic commerce shopping-mall services are implemented utilizing three-dimensional (3D) avatars each having the same appearance as a user, thereby giving the user the same effect as wearing the items the user has selected, and thus, the number of times the users have access to the shopping-mall through wired or wireless communication networks can be enhanced.

### Technical Solution

According to an aspect of the present invention for achieving the object, there is provided an electronic commerce system for the digital fashion using an avatar based on a user, which comprises a terminal for transmitting user's three-dimensional image data through a wired or wireless communication network and then selecting any one of items provided through the wired or wireless communication network to receive an avatar image wearing the selected item and to transmit purchase specification information for purchasing the selected item; an avatar creation server for receiving the three-dimensional image data from the terminal and then creating an avatar image; and a three-dimensional shopping-mall server for putting any one item selected among a plurality of items stored therein on the avatar image created by the avatar creation server to provide the terminal with the avatar image wearing the item, and then performing an electronic commerce transaction with the terminal on the receipt of the purchase specification information of the selected item.

According to another aspect of the present invention, there is provided a method of operating an electronic commerce system for the digital fashion using an avatar based on a user, which comprises the steps of receiving three-dimensional image data from a terminal of a user through a wired or wireless communication network; creating an avatar image after receiving the three-dimensional image data from the terminal; providing a plurality of items to the terminal; if one item is selected among the plurality of items, putting the selected item on a user's avatar image and providing the terminal with the avatar image wearing the item; determining whether the user wishes to buy the item that the avatar image is wearing; if it is determined that the user wishes to buy a product corresponding to the item that the avatar image is wearing, receiving purchase specification information from the terminal; and performing an electronic commerce transaction with the terminal on the receipt of the purchase specification information.

### Advantageous Effects

According to the present invention, since 3D avatars each having the same appearance as a user are used to implement the digital fashion electronic commerce shopping-mall services, the user can obtain the same effect as wearing the apparel that he/she has selected. Therefore, the number of times the users have access to the shopping-mall can be increased.

### BRIEF DESCRIPTION OF THE DRAWINGS

FIG. 1 is a block diagram illustrating a shopping-mall system utilizing user-based avatar images according to a preferred embodiment of the present invention.

FIG. 2 is a flowchart illustrating a process of operating the shopping-mall service system utilizing user-based avatar images according to a preferred embodiment of the present invention.

FIG. 3 is a flowchart illustrating a process of creating user-based avatar images using three-dimensional (3D) image data received from users in the process of operating the shopping-mall service system utilizing user-based avatar images shown in FIG. 2.

FIG. 4 is a flowchart illustrating a process of updating items in the shopping-mall service system utilizing user-based avatar images according to a preferred embodiment of the present invention.

### BEST MODE FOR CARRYING OUT THE INVENTION

Hereinafter, a preferred embodiment of the present invention will be described in detail with reference to the accompanying drawings.

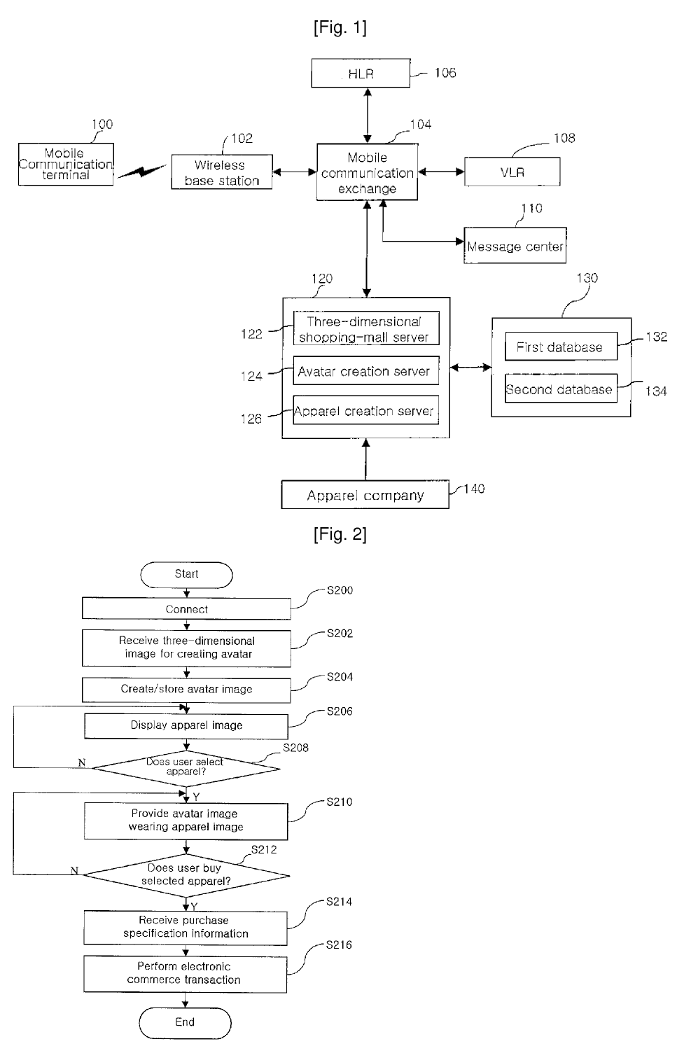

FIG. 1 is a block diagram illustrating a digital fashion electronic commerce system, i.e. a shopping-mall system utilizing user-based avatar images according to a preferred embodiment of the present invention.

Referring to FIG. 1, the three-dimensional (3D) shopping system utilizing user-based avatar images according to a preferred embodiment of the present invention comprises a mobile communication terminal 100, a wireless base station 102, a mobile communication exchange 104, a home location register (HLR) 106, a visitor location register (VLR) 108, a message center 110, a server unit 120, a database unit 130, and an apparel company 140. The server unit 120 comprises a 3D shopping-mall server 122, an avatar creation server 124, and an apparel creation server 126, and the database unit 130 comprises first and second databases 132 and 134.

The mobile communication terminal 100 connects to the avatar creation server 124 of the server unit 120 through a mobile communication network, i.e. through the wireless base station 102 and the mobile communication exchange 104 to transmit user's 3D image data and to receive a user's own 3D avatar image corresponding to the 3D image data from the avatar creation server 124. Here, the 3D image data may be obtained by scanning a user's own portrait with a 3D scanner or by scanning a user's own portrait, whole body, left or right side profile, back side or the like with a 3D scanner.

In addition, if the mobile communication terminal 100 connects to the 3D shopping-mall server 122 of the server unit 120 through a mobile communication network to select a certain apparel image among the apparel images provided by the 3D shopping-mall server 122, it receives an avatar image which has been created by the avatar creation server 124 and wears the selected apparel image. Accordingly, a user can put an apparel image selected by himself or herself on his or her own avatar image.

The mobile communication terminal 100 provides the 3D shopping-mall server 122 with purchase specification information for purchasing at least one or more of the apparel images provided by the 3D shopping-mall server 122 and performs an electronic commerce transaction with the 3D shopping-mall server 122 in accordance with the purchase specification information. Here, the purchase specification information contains user's private information, user's body-shape information and the like.

The wireless base station 102 comprises a base transceiver station (BTS) and a base station controller (BSC), although they are not shown in the figure. The BTS transmits/receives wireless signals to/from the mobile communication terminal 100, converts communication protocols, and encodes/decodes the signals. The BSC manages a plurality of BTSs and performs the communication channel allocation control or the like for the mobile communication terminal 100.

The mobile communication exchange 104 processes the request of call from the wireless base station 102 and is wired connected to each server of the server unit 120 such that the mobile communication terminal 100 can connect to each server of the server unit 120 in a wireless way.

A location register is a database for managing information on mobile communication subscribers registered in the area governed by the wireless base station 102 and temporarily storing information on a mobile communication subscriber registered in another area when the subscriber enters the service area governed by the wireless base station 102 to receive services from the wireless base station. The location register is classified into the home location register (HLR) 106 and the visitor location register (VLR) 108. The techniques related to the location registers are well known to those skilled in the art, and thus, further detailed descriptions will be omitted herein.

The message center 110 performs services of receiving predetermined data, e.g. an avatar image wearing a new apparel image, from the 3D shopping-mall server 122 after the user has created the avatar image through the mobile communication terminal 100, converting the received data into multimedia messages and then transmitting the messages to the mobile communication terminal 100.

The server unit 120 is a means for providing the mobile communication terminal 100 with shopping-mall services utilizing user-based avatar images, and may be installed within the mobile communication exchange 104 of a mobile communication network operated by a mobile communication company such as SK Telecom. Alternatively, the server unit may be installed as a separate apparatus having an independent operating system. Here, the servers in the server unit 120 are interconnected to each other.

The avatar creation server 124 of the server unit 120 receives 3D image data from the mobile communication terminal 100 through a mobile communication network, creates a user's avatar image based on the received image data, and provides or displays the avatar image to or on the mobile communication terminal 100. The created user's avatar image is stored in the first database 132.

The avatar creation server 124 provides a plurality of previously stored body images (images of bodies except portraits) and hair images to the mobile communication terminal 100 when receiving only 3D image data of a user's portrait from the mobile communication terminal 100. If any one of the plurality of body images and any one of the plurality of the hair images are selected, the avatar creation server creates a user's full-length avatar image by combining the portrait image with the selected body and hair images. At this time, the user's full-length avatar image can be updated whenever the body and hair images are selected.

The apparel creation server 126 of the server unit 120 is linked to the apparel company 140 in an off-line way and creates apparel images based on apparel pattern data obtained by scanning the apparel from the apparel company 140 with a 3D scanner and then stores the apparel images into the second database 134. That is, the apparel creation server 126 creates new apparel images and updates the data stored in the second database 134 whenever new apparels are provided from the apparel company 140.

The avatar creation server 124 and the apparel creation server 126 are provided with a 3D graphic tool such as Maya.

The 3D shopping-mall server 122 of the server unit 120 retrieves a plurality of apparel images stored in the second database 134 and provides the retrieved images to the mobile communication terminal 100 connected thereto through a mobile communication network. Further, the 3D shopping-mall serve puts an apparel image selected among the plurality of apparel images on the user's avatar image stored in the first database 132 and displays the avatar image on the mobile communication terminal 100.

The user tries and confirms a plurality of apparel images and provides the 3D shopping-mall server 122 with purchase specification information for purchasing any one of the apparel images through the user's mobile communication terminal 100, and the 3D shopping-mall server 122 performs an electronic commerce transaction with the mobile communication terminal 100 based on the purchase specification information.

In addition, the 3D shopping-mall server 122 receives personal information such as his or her own body-shape information, private information and fields of interest from the mobile communication terminal 100 and stores the received information into the first database 132. At this time, the 3D shopping-mall server stores the user's personal information into the first database 132 in correspondence with the user's avatar image.

When the apparel images stored in the second database 134 are updated, i.e. when new apparel is provided from the apparel company 140, the 3D shopping-mall server 122 determines whether a user is interested in the newly provided apparel based on the user's personal information and provides the message center 110 with a user's avatar image wearing the updated apparel image.

Then, the message center 110 processes the avatar image received from the 3D shopping-mall server 122 into a multimedia message and provides the multimedia message to the mobile communication terminal 100.

Further, the 3D shopping-mall server 122 provides the user with a user interface that can be used to rotate or move the 3D avatar image wearing the selected item in all directions. Through the user interface, the user can put on the tools such as 3D glasses and move and confirm his or her 3D avatar image.

A process of allowing the 3D shopping-mall service system so configured to create user's avatars and to perform electronic commerce transactions using the created avatars will be described with reference to FIG. 2.

FIG. 2 is a flowchart illustrating the process of operating the shopping-mall service system using a mobile communication network according to a preferred embodiment of the present invention.

Referring to FIG. 2, the user connects to the 3D shopping-mall server 122 of the server unit 120 through a mobile communication network, i.e. through the wireless base station 102 and the mobile communication exchange 104, using his or her mobile communication terminal 100 (step S200).

That is, the user operates the mobile communication terminal 100 to select a wireless Internet connection menu to connect to the 3D shopping-mall server 122 of the server unit 120, i.e. a mobile communication company's server. For example, if the user is a subscriber of SK Telecom, he/she selects the “NATE” menu and then selects a 3D shopping-mall service menu among the “NATE” menu.

Accordingly, the 3D shopping-mall server 122 provides the connected mobile communication terminal 100 with an avatar setting menu, an electronic commerce menu and the like.

If the user selects the avatar setting menu among the menus provided to the mobile communication terminal 100, the avatar creation server 124 of the server unit 120 is driven to receive 3D image data, which are used to create an avatar, from the user's mobile communication terminal 100 through a certain user interface (step S202).

That is, the user transmits the 3D image data obtained by scanning his or her portrait or whole body with a 3D scanner to the avatar creation server 124 using the mobile communication terminal 100.

The avatar creation server 124 creates a user's avatar image based on the 3D image data received from the mobile communication terminal 100 and then stores the created image into the first database 132 in order to transmit or display the created avatar image to or on the mobile communication terminal 100 according to a user's request (step S204).

Hereinafter, a process between steps 202 and 204 will be described in more detail.

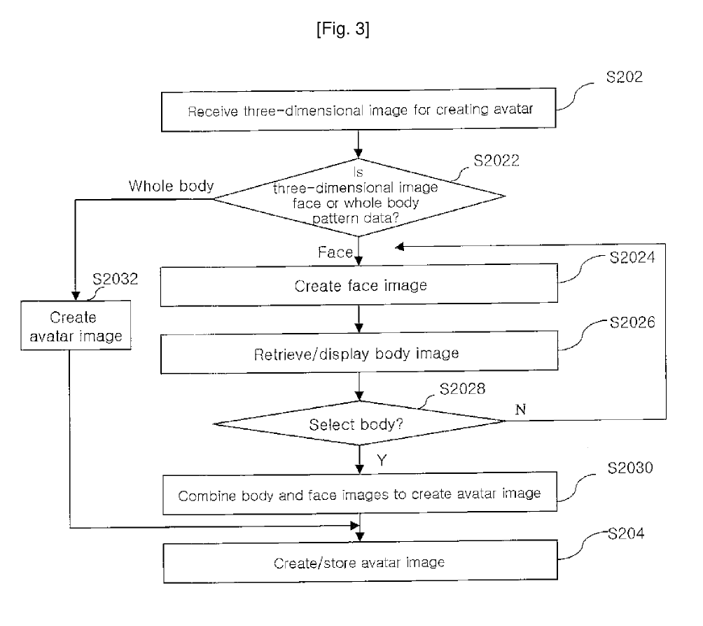

FIG. 3 is a flowchart illustrating a process of creating user-based avatar images using 3D image data received from users in the process of operating the shopping-mall service system utilizing user-based avatar images shown in FIG. 2.

Referring to FIG. 3, if the user scans him or herself with a 3D scanner, the 3D scanner creates user's 3D pattern data and provides the pattern data to the avatar creation server 124 (step S202).

The avatar creation server 124 determines whether the user's 3D image data are user's face pattern data or user's whole body pattern data (step S2022).

If it is determined in step S2022 that the 3D image data are user's face image data, the avatar creation server 124 applies the face image data to an avatar creation algorithm to create a 3D face image corresponding to the user's face (step S2024).

Next, the avatar creation server 124 retrieves 3D body images from the first database 132 and displays the retrieved body images on a display device (step S2026).

If any one of the displayed 3D body images is selected (step S2028), the avatar creation server 124 combines the selected 3D body image and the 3D face image to create a user's 3D avatar image, and then displays the created avatar image on the display device and also stores the avatar image into the first database 132 (steps S2230 and S204). At this time, the body images stored in the first database 132 are 3D body images.

If it is determined in step S2022 that the 3D pattern data are user's whole body pattern data, the avatar creation server 124 applies the body pattern data to an avatar creation algorithm to create a user's 3D avatar image, and displays the created avatar image on the display device (step S2032). Simultaneously, it proceeds to step S204 in which the created 3D avatar image is stored into the first database 132.

If the user selects a shopping-mall after an avatar image has been created and stored in this way, the 3D shopping-mall server 122 retrieves a plurality of apparel images from the second database 134 and displays the apparel images on the user's mobile communication terminal 100 (step S206).

If the user selects any one of the apparel images (step S208) in a state where the plurality of apparel images are displayed on the mobile communication terminal 100, the 3D shopping-mall server 122 causes the selected apparel image to be put on the user's avatar image and the combined avatar image on the user's mobile communication terminal 100 (step S210). At this time, the 3D shopping-mall server 122 provides the mobile communication terminal 100 with not only the avatar image but also a purchase menu for purchasing the apparel that the avatar image is wearing.

Next, if the user selects the purchase menu to purchase desired apparel corresponding to the apparel image (step S212), the 3D shopping-mall server 122 provides the mobile communication terminal 100 with an interface through which a variety of purchase specification information needed for purchasing the apparel can be inputted, and then receives the purchase specification information from the mobile communication terminal 100 (step S214). The purchase specification information can contain user's body-shape information or private information.

Then, the 3D shopping-mall server 122 performs an electronic commerce transaction with the mobile communication terminal 100 based on the purchase specification information (step S216).

The process of performing the electronic commerce transaction is generally known to those skilled in the art, and thus, detailed descriptions thereof will be omitted herein.

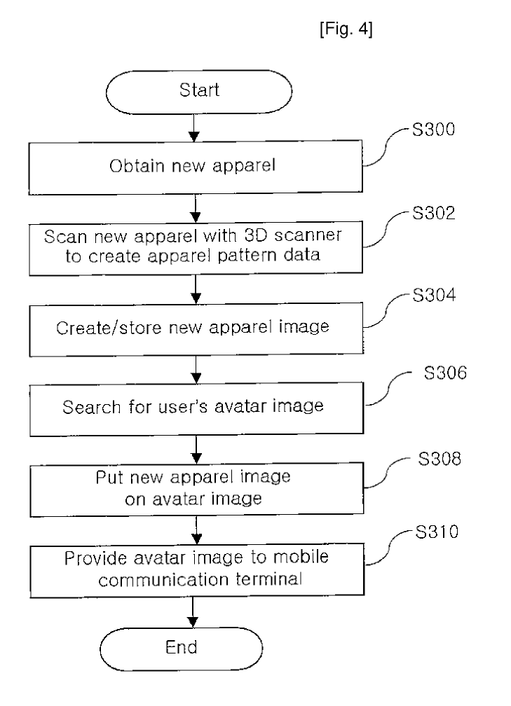

A process of updating apparel images provided from the 3D shopping-mall server 122 and providing the user with information on new apparel accordingly will be described with reference to FIG. 4.

FIG. 4 is a flowchart illustrating a process of updating apparel images in the shopping-mall service system utilizing user-based avatar images according to a preferred embodiment of the present invention.

Referring to FIG. 4, the apparel creation server 126 first obtains new apparel from the apparel company 140 in an off-line way (step S300) and creates apparel pattern data by scanning the new apparel with a 3D scanner (step S302).

The apparel creation server 126 creates a new apparel image based on the apparel pattern data and stores the created apparel image into the second database 134 (step S304).

Next, the apparel creation server 126 informs the 3D shopping-mall server 122 that new apparel has been received from the apparel company 140, and thus, the 3D shopping-mall server 122 searches the first database 132 for a user's avatar image (step S306) and puts the new apparel image stored in the second database 134 on the searched avatar image (step S308).

The 3D shopping-mall server 122 provides the message center 110 with the avatar image wearing the new apparel image, and the message center 110 then converts the avatar image received from the 3D shopping-mall server 122 into a multimedia message to provide the message to the mobile communication terminal 100 (step S310).

Here, the 3D shopping-mall server 122 does not put the new apparel image on all the avatar images. That is, based on the user's personal information stored in the first database 132, the 3D shopping-mall server 122 determines whether the new apparel is one the user wishes to wear. The 3D shopping-mall server puts the new apparel image on a user's avatar image on the basis of the above determination and provides the message center 110 with the avatar image wearing the new apparel image.

A preferred embodiment of the present invention has been described as using a mobile communication network, i.e. a wireless communication network, but a wired communication network such as the Internet and a wired terminal can also be employed.

In addition, the preferred embodiment of the present invention has been described as allowing an avatar image to wear an apparel image, but such items as accessories or shoes can be put on the avatar image and be purchased.

Although the present invention has been described in connection with the specific preferred embodiments, it will be readily understood by those skilled in the art that various modifications and changes can be made thereto without departing from the spirit and scope of the present invention defined by the appended claims. It is also apparent that the modifications and changes fall within the scope of the present invention defined by the appended claims.

### INDUSTRIAL APPLICABILITY

According to the present invention, an electronic commerce system for the digital fashion using an avatar based on an user and method for operating the same can interconnect mobile communication networks and Internet networks, and thus, value-added services of mobile communication companies and electronic commerce using mobile communications can be also widely spread.

1. An electronic commerce system for the digital fashion using an avatar based on a user, comprising:
a terminal for transmitting user's three-dimensional image data through a wired or wireless communication network and then selecting any one of items provided through the wired or wireless communication network to receive an avatar image wearing the selected item and to transmit purchase specification information for purchasing the selected item;
an avatar creation server for receiving the three-dimensional image data from the terminal and then creating an avatar image; and
a three-dimensional shopping-mall server for putting any one item selected among a plurality of items stored therein on the avatar image created by the avatar creation server to provide the terminal with the avatar image wearing the item, and then performing an electronic commerce transaction with the terminal on the receipt of the purchase specification information of the selected item.

2. The system as claimed in claim 1, wherein the three-dimensional image data are obtained by scanning a user's portrait with a three-dimensional (3D) scanner.

3. The system as claimed in claim 2, wherein the avatar creation server receives three-dimensional image data of the user's portrait to create a face image of the user, provides an interface for selecting any one of a plurality of previously created body images and any one of a plurality of previously created hair images, and combines the face image with hair and body images according to user's selection through the interface to create the user's avatar image.

4. The system as claimed in claim 1, wherein the purchase specification information contains private information or body shape information of the user.

5. The system as claimed in claim 1, further comprising an apparel creation server for creating an item based on item pattern data obtained by scanning a new item provided from an apparel company and then storing the created item into a database.

6. The system as claimed in claim 5, wherein the item pattern data are obtained by scanning the new item with a 3D scanner.

7. The system as claimed in claim 1, wherein if a new item is created, the three-dimensional shopping-mall server puts the new item on the avatar image registered by the user to provide the terminal with the avatar wearing the new item.

8. The system as claimed in claim 1, wherein the three-dimensional shopping-mall server provides the user with a user interface capable of rotating or moving the three-dimensional avatar image wearing the selected item in all directions.

9. The system as claimed in claim 7, further comprising a message center for receiving data on the avatar image wearing the new item and constructing a multimedia message thereof to provide the terminal with the multimedia message.

10. A method for operating an electronic commerce system for the digital fashion using an avatar based on a user, comprising the steps of:
receiving three-dimensional image data from a terminal of a user through a wired or wireless communication network;
creating an avatar image after receiving the three-dimensional image data from the terminal;
providing a plurality of items to the terminal;
if one item is selected among the plurality of items, putting the selected item on a user's avatar image and providing the terminal with the avatar image wearing the item;
determining whether the user wishes to buy the item that the avatar image is wearing;
if it is determined that the user wishes to buy a product corresponding to the item that the avatar image is wearing, receiving purchase specification information from the terminal; and
performing an electronic commerce transaction with the terminal on the receipt of the purchase specification information.

11. The method as claimed in claim 10, wherein a step of creating an avatar image comprises the steps of:
receiving three-dimensional image data of a user's portrait to create a face image of the user; and
providing an interface for selecting any one of a plurality of previously created body images and any one of a plurality of previously created hair images, whereby the face image are combined with hair and body images according to user's selection through the interface to create the user's avatar image.

12. The method as claimed in claim 10, further comprising the steps of:
creating item pattern data obtained by scanning an item provided by an item provider; and
creating an item based on the created item pattern data to update a plurality of the previously stored items.

13. The method as claimed in claim 12, wherein the item pattern data are obtained by scanning the new item with a 3D scanner.
